(19) United States
(12) Patent Application Publication
(10) Pub. No.: US 2016/0002484 A1
(43) Pub. Date: Jan. 7, 2016

(54) IMPROVED HYDROPHOBICITY WITH NANOFIBER AND FLUOROPOLYMER COATING

(71) Applicant: XANOFI, INC., Raleigh, NC (US)

(72) Inventors: Peter GEISEN, Raleigh, NC (US); Sumit GANGWAL, Raleigh, NC (US); Miles C. WRIGHT, Raleigh, NC (US)

(73) Assignee: Xanofi, Inc., Raleigh, NC (US)

(21) Appl. No.: 14/762,769

(22) PCT Filed: Jan. 24, 2014
(86) PCT No.: PCT/US14/12937

§ 371 Date: Jul. 22, 2015

Related U.S. Application Data
(60) Provisional application No. 61/756,939, filed on Jan. 25, 2013.

(51) Int. Cl. C09D 101/12; B05D 5/00; B05D 3/02; B05D 3/12; B05D 1/02; B05D 1/18

(52) U.S. Cl. CPC C09D 101/12; B05D 1/02; B05D 1/18; B05D 3/0272; B05D 3/12; B05D 5/00

(57) ABSTRACT

The invention relates to improved hydrophobicity and water protection of a fibrous fabric substrate (cotton, synthetics and/or their blends) by depositing a thin nanofiber layer and coating with a dispersion of fluoropolymers (fluorinated acrylic co-polymers) that are alternative perfluorinated chemicals (PFCs) based on short-chain chemistry of varying chain length (C4, C6, C8, C10, C12, C14, etc.) perfluoroalkyl constituents.

### TECHNICAL FIELD OF THE INVENTION

The present invention relates generally to application of nanofibers with oil/water repellent for textiles to improve the hydrophobicity and liquid repellency properties of fabric substrate materials to which these are applied. More specifically, the invention relates to improved hydrophobicity and water protection of a fibrous fabric substrate (cotton, synthetics and/or their blends) by depositing a thin nanofiber layer and coating with a dispersion of fluoropolymers (fluorinated acrylic copolymers) that are alternative perfluorinated chemicals (PFCs) based on short-chain chemistry of varying chain length (C4, C6, C8, C10, C12, C14, etc.) perfluoroalkyl constituents.

### BACKGROUND TO THE INVENTION

Fibers form, in part or in whole, a large variety of both consumer and industrial materials such as, for example, clothing and other textile materials, medical prostheses, construction materials and reinforcement materials, and barrier, filtration and absorbent materials. There are two main structural classes of fiber materials: woven and non-woven. An advantage of non-woven fiber materials is their lower production cost.

Nanofibers (fibers having diameters less than 1000 nm) are increasingly being investigated for use in various applications. Nanofibers may attain a high surface area comparable with the finest nanoparticle powders, yet are fairly flexible, and retain one macroscopic dimension which makes them easy to handle, orient and organize. Direct application of nanofiber webs or thin nanofiber layers onto garment systems can be utilized in protective textiles as breathable barriers to liquid penetration. For example, the U.S. Army Natick Soldier Center has investigated enhancement of barrier materials using a fine nanofiber layer to prevent penetration of chemical warfare agents in aerosol form. The study (Schreuder-Gibson et al., 2002) found that nanofibers of certain polymers (e.g. nylon 6,6, polybenzimidazole, polyacrylonitrile and polyurethane) provided good aerosol particle protection, without a significant change in moisture vapor transport of the system. Further, it has been found that polypropylene webs and laminates significantly enhanced barrier performance for challenge liquids having varying surface tensions. Though ultrathin nanofiber webs have exciting and unique properties, they have limited mechanical properties. The nanofiber webs are used in a composite structure with some other substrate material as a support to provide strength and durability. For use in protective clothing, nanofiber webs can be used as a component in layered fabric systems such that the protection and comfort is accessed in layered structures.

Wettability is an important property of fibrous materials for many applications. Both surface energy and surface roughness are the dominant factors for wettability or hydrophobicity of materials. The degree of wettability of a solid surface can be evaluated by contact angle (CA), a numerical value given by Young's equation. Young's Equation defines the balances of forces caused by a wet drop on a dry surface and relates the CA to three interfacial surface energies (or surface tensions) between the solid and the liquid, the liquid and the vapor, and the solid and the vapor. A water droplet is typically used as the probing liquid although some organic and ionic liquids have also been deployed. The CA can be measured from the plane of the surface. Inspired by the hydrophobic behavior of plant surfaces and animal skins, during the past decade, much research has been placed to fabricate artificial surfaces and coatings with high CAs that mimic those naturally delicate choices via millions of years' evolutions. Hydrophobicity refers to the physical property of a surface on which hydrophobic molecules repel water molecules causing higher water CAs, 74 , over 90°. A hydrophobic surface does not allow the spread of water on it. The water stands up in the form of droplets.

Nanofibers can be used to impart surface roughness of a material thereby increasing the hydrophobicity of that material. Surface roughness may be enhanced by a repellant coating and additives such as grapheme and TiO₂. When the true CA is greater than 90°, then the angle can be increased by surface roughness.

Surface protection and fluorosurfactant products are used for many applications including carpet care, fire-fighting foam, leather, coatings, paper packaging, stone, tile and concrete coatings, and textiles. For textile applications, long-chain perfluorinated substances including perfluorinated surfactants or fluorosurfactants (perfluorinated alkylsulfonates such as Perfluorooctanesulfonic acid (PFOS) and perfluorinated carboxylates such as Perfluorooctanoic acid (PFOA)) have been widely used as water and oil repellents in fabrics and leather for stain protection applications. These compounds have unique properties to make materials stain, oil and water resistant. They can provide water and oil repellent effects on base fabric material as well as protection against chemicals, such as acids, without impairing the original softness and breathability of the fabric.

PFOS is classified as a persistent, bio-accumulative and toxic (PBT) and there are restriction on its marketing and use in different regions of the world. PFOA is bio-persistent, but is neither bio-accumulative nor toxic. In early 2006, the U.S. Environmental Protection Agency (EPA) launched the EPA 2010/2015 PFOA Stewardship Program to reduce human and environmental exposure of these compounds. The goal is to eliminate PFOA, PFOA precursors and related higher homologue chemicals from emissions and products no later than 2015. Alternative fluorotechnology or perfluorinated chemicals (PFCs) based on short chain molecules which cannot break down into PFOA have been developed and are entering the marketplace as a means to eliminate usage of PFOA, PFOA precursors and related higher homologue chemicals. These alternative PFC products are based on perfluorinated side chains with varying perfluoroalkyl constituent chain length (C4, C6, C8, C10, C12, C14, etc.) with emphasis on C8 and C6. For example, in one alternative PFC, the perfluoroalkyl constituent chains of C8 or C6 are bonded to a carboxylic acid group which is bonded to a carbon group on a main chain containing carbon and hydrogen.

The alternative PFC products, based on short-chain chemistry, provide a step-change reduction in trace impurities of PFOA below the limit of detection without compromising fluorine efficiency, offering similar or even better performance than their predecessors. Potential application of these materials include use as a stain-release finish for cotton, man-made fibers (synthetics) and blends facilitating easier removal of water- and oil-based stains during the laundering process; as an oil-, water- and stain-repellent finish for man-made fibers and blends enables spills to be blotted up quickly with a clean, dry, absorbent cloth. Treated fabrics are breathable and comfortable to wear, and the finishes remain durable after laundering. The products offer a considerable improvement in sustainability since the short-chain perfluorinated molecules that cannot break down to PFOA in the environment.

Accordingly, an ongoing need remains for improved techniques for application as an oil-, water- and stain-repellant finish using alternative PFCs.

### SUMMARY OF THE INVENTION

The present invention comprises a fabric substrate coated with polymeric nanofibers and alternative PFCs for improved hydrophobicity and water repellency of the base substrate. The fabric substrate will have improved hydrophobicity and water repellency when coated with nanofibers and alternative PFCs in comparison to the same fabric substrate coated only with alternative PFCs. The polymeric nanofibers and alternative PFCs can be applied by one of the following methods:
A) According to one implementation, polymeric nanofibers are first wet laid onto a fabric substrate of cotton, synthetic or blend fibers and allowed to dry or oven baked or heat pressed to dry. Then the nanofiber-coated substrate material is dipped into a dilute solution containing alternative PFCs (based on perfluorinated side chains with varying perfluoroalkyl constituent chain lengths) and then heat pressed or oven baked to dry the composite substrate.
B) According to another implementation, nanofibers are dip impregnated onto a fabric substrate of cotton, synthetic or blend fibers and allowed to dry or oven baked or heat pressed to dry. Then the nanofiber-coated substrate material is dipped into a dilute solution containing alternative PFCs and then heat pressed or oven baked to dry.
C) According to another implementation, nanofibers are sprayed and aerosolized onto a fabric substrate of cotton, synthetic or blend fibers and allowed to dry. Then the nanofiber-coated substrate material is dipped into a dilute solution containing alternative PFCs and then heat pressed or oven baked to dry.
D) According to another implementation, nanofibers and alternative PFCs in the same solution together are either wet-layed, dip impregnated or sprayed onto a fabric substrate of cotton, synthetic or blend fibers and allowed to dry. Then the composite material is heat pressed or oven baked.

A wide variety of polymers may be utilized as starting materials, examples of which are given below. A wide variety of alternative PFCs may be utilized as starting materials, examples of which are given below. A wide variety of fabric substrates of natural, synthetic or blend fibers may be utilized as starting materials, examples of which are given below.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic representation of nanofibers coated on a substrate of synthetic fibers with added alternative PFCs (based on perfluorinated side chains with varying perfluoroalkyl constituent chain lengths).

FIG. 2 is a Scanning electron microscopy (SEM) image of nanofibers deposited on a substrate coated with alternative PFCs at (A) 1 gram per square meter (GSM) basis weight and (B) 2 GSM. The substrate top side that was coated with nanofibers is comprised of polyester fibers and the substrate back side is comprised of cellulose fibers.

FIG. 3 is the contact angle of a water droplet deposited on a substrate (A) coated with alternative PFCs, and on one (B) coated with nanofibers and alternative PFCs.

### DETAILED DESCRIPTION

As used herein, the term nanofiber refers generally to an elongated fiber structure having an average diameter ranging from less than 50 nm-2 μm. The “average” diameter may take into account not only that the diameters of individual nanofibers making up a plurality of nanofibers formed by implementing the presently disclosed method may vary somewhat, but also that the diameter of an individual nanofiber may not be perfectly uniform over its length in some implementations of the method. In some examples, the average length of the nanofibers may range from 10 micros or greater. In other examples, the average length may range from 110 microns to over 25 centimeters. In some examples, the aspect ratio (length/diameter) of the nanofibers may range from 10:1 or greater. In some specific examples, nanofibers of the current invention may have aspect ratios of at least 10,000:1. Insofar as the diameter of the nanofiber may be on the order of two microns or less, for convenience the term “nanofiber” as used herein encompasses both nano-scale fibers and extremely small micro-scale fibers (microfibers).

As used herein, the term fibril refers generally to a fine, filamentous non-uniform structure in animals or plants having an average diameter ranging from about 1 nm-1,000 nm in some examples, in other examples ranging from about 1 nm-500 nm, and in other examples ranging from about 25 nm-250 nm. According to certain methods described below, fibrils are formed by phase separation from nanofibers. In these methods, a fibril may be composed of an inorganic precursor or an inorganic compound. In the present disclosure, the term “fibrils” distinguishes these structures from the polymer nanofibers utilized to form the inorganic fibrils. The length of the fibrils may be about the same as the polymer nanofibers or may be shorter.

Polymers encompassed by the present disclosure generally may be any naturally-occurring or synthetic polymers capable of being fabricated into nanofibers. Examples of polymers include many high molecular weight (MW) solution-processable polymers such as polyethylene (more generally, various polyolefins), polystyrene, cellulose, cellulose acetate, poly(L-lactic acid) (PLA), polyacrylonitrile (PAN), polyvinylidene difluoride (PVDF), conjugated organic semiconducting and conducting polymers, biopolymers such as polynucleotides (DNA) and polypeptides, etc.

Other examples of suitable polymers to form nanofibers include vinyl polymers such as, but not limited to, cellulose acetate propionate, cellulose acetate butyrate, polyethylene, polypropylene, poly(vinyl chloride), polystyrene, polytetrafluoroethylene, poly(α-methylstyrene), poly(acrylic acid), poly(isobutylene), poly(acrylonitrile), poly(methacrylic acid), poly(methyl methacrylate), poly(1-pentene), poly(1,3-butadiene), poly(vinyl acetate), poly(2-vinyl pyridine), 1,4-polyisoprene, and 3,4-polychloroprene. Additional examples include nonvinyl polymers such as, but not limited to, poly(ethylene oxide), polyformaldehyde, polyacetaldehyde, poly(3-propionate), poly(10-decanoate), poly(ethylene terephthalate), polycaprolactam, poly(11-undecanoamide), poly(hexamethylene sebacamide), poly(m-phenylene terephthalate), poly(tetramethylene-m-benzenesulfonamide). Additional polymers include those falling within one of the following polymer classes: polyolefin, polyether (including all epoxy resins, polyacetal, polyetheretherketone, polyetherimide, and poly(phenylene oxide)), polyamide (including polyureas), polyamideimide, polyarylate, polybenzimidazole, polyester (including polycarbonates), polyurethane, polyimide, polyhydrazide, phenolic resins, polysilane, polysiloxane, polycarbodiimide, polyimine, azo polymers, polysulfide, and polysulfone.

As noted above, the polymer used to form nanofibers can be synthetic or naturally-occurring. Examples of natural polymers include, but are not limited to, polysaccharides and derivatives thereof such as cellulosic polymers (e.g., cellulose and derivatives thereof as well as cellulose production byproducts such as lignin) and starch polymers (as well as other branched or non-linear polymers, either naturally occurring or synthetic). Exemplary derivatives of starch and cellulose include various esters, ethers, and graft copolymers. The polymer may be crosslinkable in the presence of a multifunctional crosslinking agent or crosslinkable upon exposure to actinic radiation or other type of radiation. The polymer may be homopolymers of any of the foregoing polymers, random copolymers, block copolymers, alternating copolymers, random tripolymers, block tripolymers, alternating tripolymers, derivatives thereof (e.g., graft copolymers, esters, or ethers thereof), and the like.

By fabric substrate is meant natural or synthetic fabrics composed of fibers of cotton, cellulose, acetate, rayon, silk, wool, hemp, polyester, spandex (including LYCRA), polypropylene, polyolefins, polyamide, nylon, aramids (e.g. Kevlar®, Twaron®, Nomex, etc.), acrylic, or poly (trimethylene terephthalate). By “fabric blends” is meant fabrics of two or more types of fibers. Typically these blends are a combination of a natural fiber and a synthetic fiber, but can also include a blend of two natural fibers or two synthetic fibers.

Superior oil- and water-repellency properties can be imparted to fabrics and fabric blends by the addition of certain fluorochemical copolymers (e.g. OLEOPHOBOL® CP-C High Conc fabric protector product from Huntsman). These can be applied to the fabric substrates in the form of an emulsion or dispersion in water or other solvent before, after or during application of other fabric treating chemicals.

Nanofibers impart surface roughness to a substrate material and can increase the hydrophobicity. When the true CA is greater than 90°, then the angle can be increased by surface roughness according to the Wenzel equation which relates the contact angle to the change in contact angle (termed Wenzel contact angle) by the ratio of actual area to projected area that occurs when a liquid is in intimate contact with a microstructured surface.

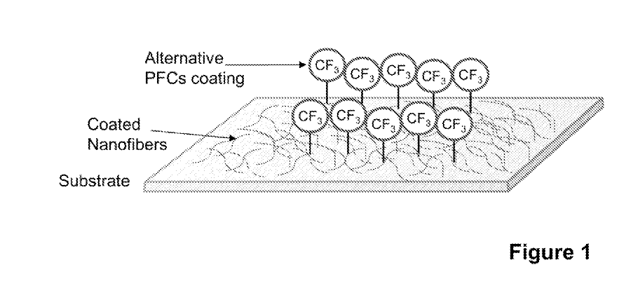

Nanofibers can be applied to the substrate fiber or synthetic blend using a variety of methods including but not limited to two-sided spraying, dip-impregnation, and wet-laying of nanofibers followed by coating with the alternative PFC materials. Nanofibers enhance the hydrophobicity and liquid repellency of the base substrate when combined with the alternative PFCs coating. The nanofibers impart additional surface roughness to the material which combines in a synergistic manner with the alternative PFCs to improve liquid repellency (FIG. 1). Nanofibers of different length and different diameter can also be mixed into a dilute alternative PFC Oleophobol solution (concentration of 10 g/l or 0.1% on the weight of the bath). The receiving fabric substrate of synthetic or blend fibers is stretched on a 10″-12″ metal frame. The mixture of nanofibers and alternative PFC solution is added to the substrate by two-sided spraying or dip-impregnation. For dip impregnation, the fabric substrate is quickly dipped into pans of mixture solution. All samples are allowed to air dry. Samples are then inserted into an oven at 380 degrees (±5 degrees) for approximately 15 seconds.

### EXAMPLE

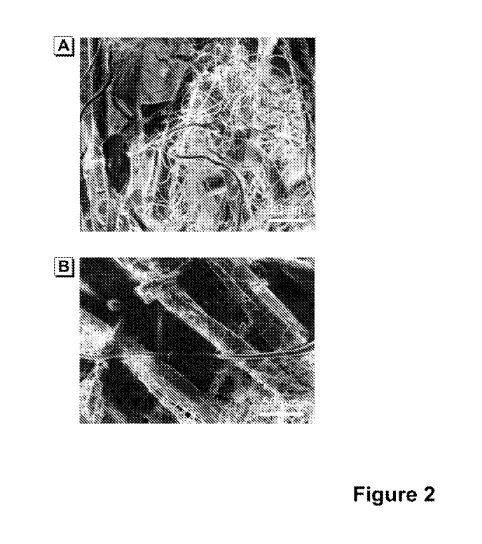

Wet laying process: Cellulose acetate (Eastman CA-398-10) nanofibers (average diameter of 400 nm and lengths of ˜200-700 μm or 2-10 mm as seen in the Table below) were first wet-layed (1 to 2 GSM basis weight) onto a fabric substrate of polyester fibers. The back side of the fabric substrate was cellulose material. A dilute solution containing glycerol and water with suspended Cellulose acetate nanofibers (˜0.1% solids) was poured onto the polyester fabric substrate placed on top of a filter fabric (80 mesh size). A wet-dry shop vacuum (Shop-Vac 6-Gallon 3 Peak HP) was used to pull vacuum to drain the liquid through the filter fabric and lay the nanofibers down on top of the polyester fabric substrate. The sample was then washed and then heat pressed or oven baked. The SEM images in FIG. 2 shows the nanofibers deposited on the fabric substrate of polyester at a basis weight of (A) 1 and (B) 2 GSM. Finally, the nanofiber-coated polyester fabric substrate was dipped into a aqueous bath containing Oleophobol 7858 (Oleophobol CP-C) at a concentration of 10 g/l or 0.1% on the weight of the bath. The dispersion of fluoropolymers was allowed to dry and then either heat pressed for one minute at 171° C. or oven baked for one minute at 193° C. (380° F.). The polyester fabric substrate sample was thus coated with cellulose acetate nanofibers and with oleophobol alternative perfluorinated compounds (PFCs).

Contact angle measurement: Water droplet side profiles were measured with a drop shape analyzer consisting of a level stage, white light source and 5.0 megapixel Sony DSC-V1 digital camera attached to a microscope head. The microscope head and camera lens allowed for a maximum total visual magnification up to 60×. The coated and uncoated fabric substrates studied had high contrast with the dark background. Side view photographs were taken. ImageJ (version 1.45) software was used to measure the cross-sectional area A, drop height h, contact radius a, and contact angle θ from the digital images.

TABLE
Contact Angle Measurement Data

| | NF Avg. | | NF Weight | Heat | Contact |
|---|---|---|---|---|---|
| Sample Name | Dia. (nm) | NF length | Basis (GSM) | Process | Angle (°) |
| Control_Baked_1_114_Fit | — | — | 0 | Baked 1 min | 114 |
| | | | | 380° F. | |
| Control_Pressed_1_115_Fit | — | — | 0 | Heat Press | 115 |
| | | | | 1 min 171° C. | |
| 1gsm_Chopped_Baked_1_136_Fit | 400 nm | Chopped; | 1 | Baked 1 min | 136 |
| | | 200-700 μm | | 380° F. | |
| 1gsm_Chopped_Pressed_1_137_Fit | 400 nm | Chopped; | 1 | Heat Press | 137 |
| | | 200-700 μm | | 1 min 171° C. | |
| 1gsm_Whole_Baked_1_132_Fit | 400 nm | Whole; 2-10 | 1 | Baked 1 min | 132 |
| | | mm | | 380° F. | |
| 1gsm_Whole_Pressed_1_136 | 400 nm | Whole; 2-10 | 1 | Heat Press | 136 |
| | | mm | | 1 min 171° C. | |
| 2gsm_Chopped_Baked_1_134_Fit | 400 nm | Chopped; | 2 | Baked 1 min | 134 |
| | | 200-700 μm | | 380° F. | |
| 2gsm_Chopped_Pressed_1_140_Fit | 400 nm | Chopped; | 2 | Heat Press | 140 |
| | | 200-700 μm | | 1 min 171° C. | |
| 2gsm_Whole_Baked_1_135_Fit | 400 nm | Whole; 2-10 | 2 | Baked 1 min | 135 |
| | | mm | | 380° F. | |
| 2gsm_Whole_Pressed_1_136_Fit | 400 nm | Whole; 2-10 | 2 | Heat Press | 136 |
| | | mm | | 1 min 171° C. | |

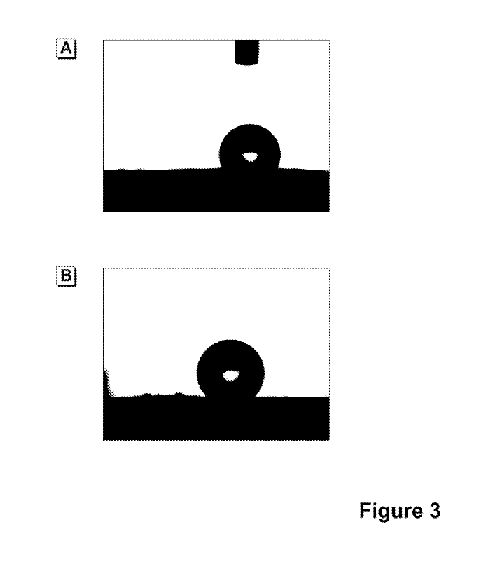

The table above lists contact angles for the samples tested. The first two control samples of polyester fabric substrate coated with Oleophobol 7858 that were oven backed and heat pressed had contact angle measurements of 114° and 115°, respectively. Adding 1 or 2 grams per square meter (GSM) of nanofibers to the polyester fabric substrate and then coating with Oleophobol 7858 increased the hydrophobic contact angle (range of)132-140° . FIG. 3 shows two sample images at a contact angle of (A) 114° and (B) 137° for the control pressed and added nanofibers at 1 GSM pressed samples, respectively. The average contact angle of the oleophobol-coated substrate samples with 1 GSM of nanofiber was 135.3°, whereas when 2 GSM nanofibers were laid down on the polyester fabric substrate the average contact angle increased to 136.3°. The heat treatment did affect the contact angle of the nanofiber-coated substrate. However, the trend was different depending on fiber length for the 1 GSM and 2 GSM coated substrates. For the substrates that had 1 GSM of nanofibers that were not chopped short and longer in length (2-10 mm), the contact angle was different depending on the heat treatment-132° for baked and 136° for heat pressed. For the substrates that had 2 GSM of nanofibers that were chopped (2-10 mm), the contact angle was different depending on the heat treatment-134° for baked and 140° for heat pressed.

What is claimed is:

1. A method to increase the hydrophobicity, water and/or liquid repellency of synthetic, cellulose or blend fibrous substrates, comprising applying a thin layer of nanofibers in combination with a dispersion of fluoropolymers (alternative PFCs or a polymer comprised perfluoroalkyl groups) to the substrate, wherein the coated substrate has an irregular surface (or surface roughness) due to the thin coated layer of nanofibers.

2. The method of claim 1, wherein the nanofibers are applied onto the substrates by wet laying, spraying, or dip-impregnation.

3. The method of claim 1, further comprising coating the nanofiber-coated substrate with perfluorinated compounds.

4. The method of claim 1, wherein the nanofibers and the dispersion of fluoropolymers are mixed together and deposited at the same time onto the substrate.

5. The method according to claim 1, further comprising air drying the coated substrates followed by heat pressing or oven baking.

6. The method of claim 1, wherein the basis weight amount of coating ranges from 0-5 grams per square meter or greater.

7. The method of claim 1, wherein the coating is of a dispersion of fluoropolymers in the amount of 0.1 to 25 weight % based on the weight of the coated substrate area.

8. The method of claim 1, wherein the polymeric nanofibers have an average diameter 1 nm to 5 μm or greater and short cut lengths 1-1000 μm or 2-10 mm or greater.

9. A substrate coated with nanofibers and alternative PFCs obtained by the method according to claim 1.

10. A coated synthetic, cellulose or blend fibrous substrate, having a contact angle more than 110°.

11. The coated synthetic, cellulose or blend fibrous substrate according to claim 10, having a contact angle more than 120°.

12. The coated synthetic, cellulose or blend fibrous substrate according to claim 11, having a contact angle more than 130°.

13. The coated synthetic, cellulose or blend fibrous substrate according to claim 12, having a contact angle more than 140°.
